(19) United States
(12) Patent Application Publication
(10) Pub. No.: US 2022/0163077 A1
(43) Pub. Date: May 26, 2022

(54) Disk Brake and Brake Pad

(71) Applicant: KNORR-BREMSE SYSTEME FÜR NUTZFAHRZEUGE GMBH, München (DE)

(72) Inventors: Andreas PETSCHKE, Neuburg am Inn (DE); Matthias ADELUNG, Fuerstenzell (DE); Jens FRICKE, Vilshofen (DE); Josef SCHROPP, Eichendorf (DE)

(21) Appl. No.: 17/594,318

(22) PCT Filed: Mar. 27, 2020
(86) PCT No.: PCT/EP2020/058790

§ 371 Date: Oct. 11, 2021

(30) Foreign Application Priority Data
Apr. 12, 2019 (DE) 10 2019 109 817.3

(51) Int. Cl. F16D 55/226; B60T 1/06; F16D 65/12; F16D 65/095; F16D 65/00

(52) U.S. Cl. CPC F16D 55/226; B60T 1/065; F16D 2055/0045; F16D 65/095; F16D 65/0056; F16D 65/12

(57) ABSTRACT

An electrically or pneumatically activated disc brake for a commercial vehicle includes: a brake disc having a preferred rotating direction; a brake carrier; a brake caliper guided so as to be displaceable on the brake carrier; a tensioning-side brake pad and a reaction-side brake pad which, in a tensioning-side pad take-up and in a reaction-side pad take-up, are disposed so as to be displaceable parallel to a brake disc rotation axis; and a tensioning device which has a single compression piston with a central axis and which on an end facing the tensioning-side brake pad has a compression piece which by way of a compression face acts on a corresponding counter bearing face of the tensioning-side brake pad such that, when tensioning the brake, an effective area is configured between the compression face and the counter bearing face. The tensioning-side brake pad and the reaction-side brake pad in the circumferential direction are aligned so as to be centered in terms of the brake disc and the central axis of the piston. The effective area, on which the compression face and the counter bearing face bear on one another when tensioning the disc brake, in the circumferential direction lies so as to be offset toward the egress side in terms of the preferred rotating direction of the brake disc and the central axis of the piston.

### BACKGROUND AND SUMMARY OF THE INVENTION

The invention relates to a disc brake for a commercial vehicle, having a brake disc with a preferred rotating direction; a brake carrier; a brake caliper guided so as to be displaceable on the brake carrier; a tensioning-side brake pad and a reaction-side brake pad which, in a tensioning-side pad take-up and in a reaction-side pad take-up of the brake carrier, are disposed so as to be displaceable parallel to a brake disc rotation axis; a tensioning device with a single compression piston having a central axis and which, on an end facing the tensioning-side brake pad, a compression piece by way of which a compression face acts on a corresponding counter bearing face of the tensioning-side brake pad such that, when tensioning the brake, an effective area is configured between the compression face and the counter bearing face. The tensioning-side brake pad and the reaction-side brake pad in the circumferential direction are aligned so as to be centered in terms of the brake disc and the central axis of the piston. The invention further relates to a brake pad for such a disc brake.

EP 2 392 835 B1 is cited in terms of the prior art.

According to this prior art it is known for measures in terms of construction to be initiated to counter oblique wear on the pads on disc brakes of heavy commercial vehicles having brake carriers and sliding calipers and a tensioning device having only a single compression piston.

In terms of the preferred rotating direction of the brake disc here, one or both brake pads in the circumferential direction are offset toward the ingress side or the egress side in terms of the brake disc.

In terms of construction this is typically comparatively complex because the pad take-ups in the brake carrier are typically offset in a corresponding manner. It is also known for a corresponding offset to be performed by chamfers or bevels, respectively, on the friction materials, this however reducing the effective friction face between the friction material and the brake disc.

In contrast, the invention is based on the object of achieving an alternative measure for reducing the effect of oblique wear on the brake pads, said measure not requiring any offset of a pad in the circumferential direction.

According to the invention, an electrically or pneumatically activatable disc brake for a commercial vehicle, said disc brake thus also being preferably electrically or pneumatically activated when in operation, has the following features: a brake disc having a preferred rotating direction; a brake carrier; a brake caliper which is guided so as to be displaceable on the brake carrier; a tensioning-side brake pad and a reaction-side brake pad; a tensioning device which has a single compression piston which has a central axis and which on an end facing the tensioning-side brake pad has a compression piece which by way of a compression face acts on a corresponding counter bearing face of the tensioning-side brake pad such that, when tensioning the brake, an effective area is configured between the compression face and the counter bearing face. The tensioning-side brake pad and the reaction-side brake pad in the circumferential direction are aligned so as to be centered in terms of the brake disc and the central axis of the piston. The effective area, on which the compression face and the counter bearing face bear on one another when tensioning the disc brake, in the circumferential direction lies so as to be offset toward the egress side in terms of the preferred rotating direction of the brake disc and the central axis of the piston.

A particular advantage of this design embodiment lies in that, also in a disc brake which has only a single compression piston and in which both the brake pads in the circumferential direction are aligned so as to be centered in terms of the brake disc, oblique wear on the brake pads can be counteracted, without an offset of a pad and/or the associated pad take-up thereof, simply in that the compression piece and/or the backplate of the brake pad are/is modified such that the effective area in the circumferential direction lies so as to be eccentric, or is not centric and aligned so as not to be centered in terms of the brake disc, respectively. This measure is able to be implemented in a simple manner in a retrofit process, or by a simple constructive modification of the elements comprising the compression piece and/or the tensioning-side brake pad.

It is preferable for the compression piston to comprise a first, preferably cylindrical or partially cylindrical, portion and the compression piece, at least when tensioning the disc brake, to act on the tensioning-side brake pad. It can furthermore be provided that the brake disc has a diameter of 15″ or more, because it is particularly advantageous in the case of sliding caliper disc brakes of this type having a relatively large disc diameter that measures against oblique wear can be implemented without an offset of the pad take-ups, which is complex in terms of construction, and also without reducing the effective pad friction face by chamfers or the like.

It can advantageously be provided that the tensioning-side brake pad and the reaction-side brake pad are disposed in a tensioning-side pad take-up and (that is to say, or) disposed in a reaction-side pad take-up of the brake carrier. It can furthermore advantageously be provided that the brake caliper and the brake carrier in the manner of a frame engage in each case across the upper periphery of the brake disc, wherein a central opening for changing pads is provided in the brake caliper. This means that the brake pads are inserted into the brake carrier through the central opening of the brake caliper, and are extracted again in the opposite direction.

In such brakes it is in turn very advantageous that an offset of the brake pads in the circumferential direction can be dispensed with according to the invention, such that the length of the opening of the brake caliper in the circumferential direction can correspond substantially to the length of the pad.

To this end, it can advantageously be furthermore provided that the pad take-ups of the brake carrier in the circumferential direction are aligned so as to be centered in terms of the brake disc.

It can be provided that the brake pads have in each case one backplate and one friction material, wherein the friction materials and/or the backplate in the circumferential direction are preferably aligned so as to be centered in terms of the brake disc. These design embodiments in turn are very advantageous because a particularly large friction face and a particularly simple construction of the backplate can be ensured as a result. The backplate and the friction materials of both brake pads of a disc brake in the circumferential direction are particularly preferably aligned toward the piston.

The invention in terms of construction can be advantageously refined.

For implementing the egress-side offset of the effective area it can thus be provided that the compression piece has a protrusion which comprises the compression face and that the compression face, in terms of the preferred rotating direction of the brake disc, in the circumferential direction is disposed so as to be offset toward the egress side.

For implementing the egress-side offset of the effective area it can however also be provided that the counter bearing face of the backplate, in terms of the preferred rotating direction of the brake disc, in the circumferential direction is disposed so as to be offset toward the egress side.

For implementing the egress-side offset of the effective area it can finally also be provided that the counter bearing face of the backplate that is offset toward the egress side is configured by an appendage of the backplate. Said appendage can be simply formed by an element attached to the backplate. It can furthermore simply be provided here that the element attached to the backplate is a sheet-metal element which is fastened to the backplate.

The invention moreover also provides a brake pad for a disc brake, said brake pad in terms of the line of gravity of the brake pad, having a, preferably single, eccentric counter bearing face for a compression piston having a compression face. This brake pad in this manner is advantageously improved in terms of function, and the egress-side offset of the effective area can be implemented in a particularly simple manner. To this end it can be provided, for example, that the single eccentric counter bearing face is configured so as to be substantially semicircular or configured so as to be completely semicircular.

The invention also provides a vehicle having at least one wheel axle, wherein the wheel axle in terms of a or the primary travel direction of the vehicle has a primary rotating direction, and wherein the wheel axle on the left vehicle side has at least one disc brake assigned to a left end (and a wheel) of the wheel axle, and wherein the wheel axle on the right vehicle side has at least one disc brake assigned to a right end (and a wheel), wherein the disc brake on the left vehicle side and the disc brake on the right vehicle side are in each case configured according to the invention. The brake discs of the two disc brakes can be connected in a rotationally fixed manner to the wheel axle.

In this way, disc brakes according to the invention are advantageously disposed and used as a disc brake on the left vehicle side and the disc brake on the right vehicle side(s) on a vehicle. The vehicle has a plurality of axles having left and right wheels. At least one or a plurality of these wheel axles in the end regions is or are provided with disc brakes according to the invention.

According to one advantageous variant, the respective left and the respective right side disc brakes here can differ from one another only in terms of the brake pads and the backplates of said disc brakes.

A recess of the tensioning-side brake pad that lies below the compression face, for example in the case of a right disc brake, in a tensioning-side brake pad in the installed state in the backplate can thus entirely or largely lie more toward one side, for example the right ingress-side, of the central axis, and in the case of the corresponding left disc brake, in a tensioning-side brake pad in the installed state in the backplate can thus entirely or largely lie more toward the other side, for example the left side, of the central axis. The tensioning by way of the tensioning device here is performed from the center of the vehicle to the outside (to the right or left) toward the respective wheel. The primary travel direction is the forward travel. The forward travel determines the primary rotating direction of the brake disc. It can be advantageous here to mark whether a brake pad is provided for a disc brake on the left vehicle side or for a disc brake on the right vehicle side, for example in that the tensioning-side brake pad for the disc brake which in the travel direction is on the left vehicle side and the tensioning-side brake pad for the disc brake on the right vehicle side are provided with suitable markings such as, for example, “L” for “disc brake on the left vehicle side” and, for example, “R” for “disc brake on the right vehicle side” (in the context of the travel direction of the vehicle).

For electrical or pneumatic activation, the disc brake can be assigned an actuator, or said disc brake can have said actuator. For electrical activation, for example, the actuator can have an electric motor and preferably a gearbox which acts on the tensioning device, or else for pneumatic activation, for example, can have a compressed-air cylinder which activates the disc brake preferably by way of a piston rod. The disc brake thus becomes in each case an electrically or pneumatically activated disc brake.

The invention will be described in more detail hereunder by means of exemplary embodiments. The invention is not exhaustively illustrated by said exemplary embodiments but within the scope of the claims can also be implemented in a different manner not illustrated.

### BRIEF DESCRIPTION OF THE DRAWINGS

FIG. 1 shows a view of part of its brake caliper, a disc brake having a brake carrier, a brake caliper and a tensioning installation, when viewed in the direction toward a compression piece of the tensioning installation;

FIG. 2 shows a perspective view of a compression piston having a compression piece;

FIG. 3 shows a plan view of an assembly having a brake carrier, brake pads and a compression piston;

FIGS. 4A and 4B show different views of a tensioning-side brake pad; and

FIGS. 5A and 5B show different views of an alternative design embodiment of a tensioning-side brake pad;

FIG. 6A shows a perspective view of a tensioning-side brake pad for a disc brake on the left vehicle side, wherein it is illustrated by a circular area where a preferably flat compression face of a compression piece acts on the backplate;

FIG. 6B shows a tensioning-side brake pad for a disc brake on the left vehicle side; and

FIG. 6C shows a tensioning-side brake pad for a disc brake on the right vehicle side, wherein the recess or depression of the brake pad on which the compression piece acts in the case of the left disc brake lies further toward the left on the backplate and in the case of the right disc brake lies further toward the right.

The individual features of the disc brakes described hereunder do not in each case have to be mandatorily used in combination with all of the further features of these exemplary embodiments. Said features in other design embodiments can rather also be in each case used individually or in combination with further features of these disc brakes. Moreover, the exemplary embodiments illustrated can also vary in terms of details.

### DETAILED DESCRIPTION OF THE DRAWINGS

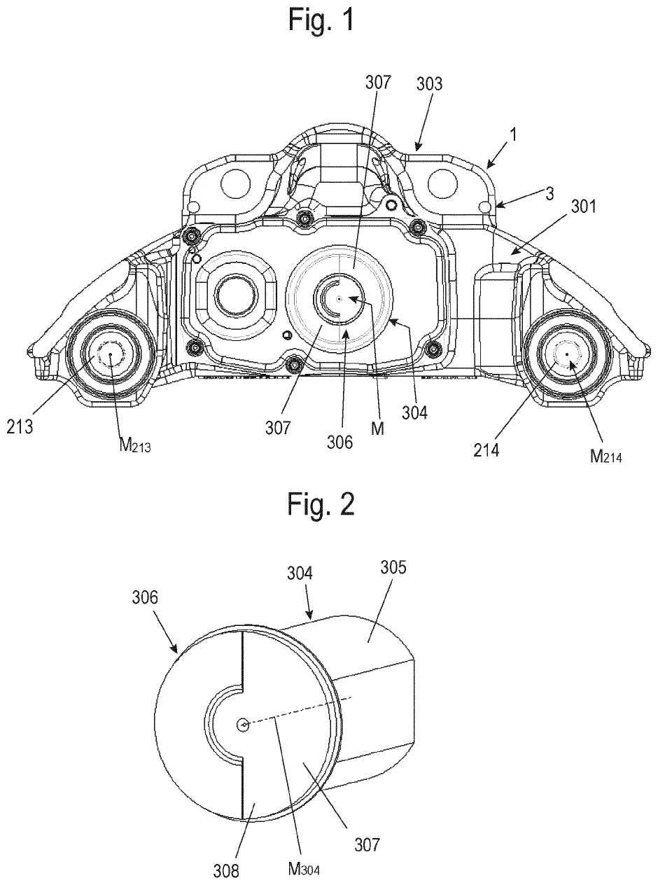

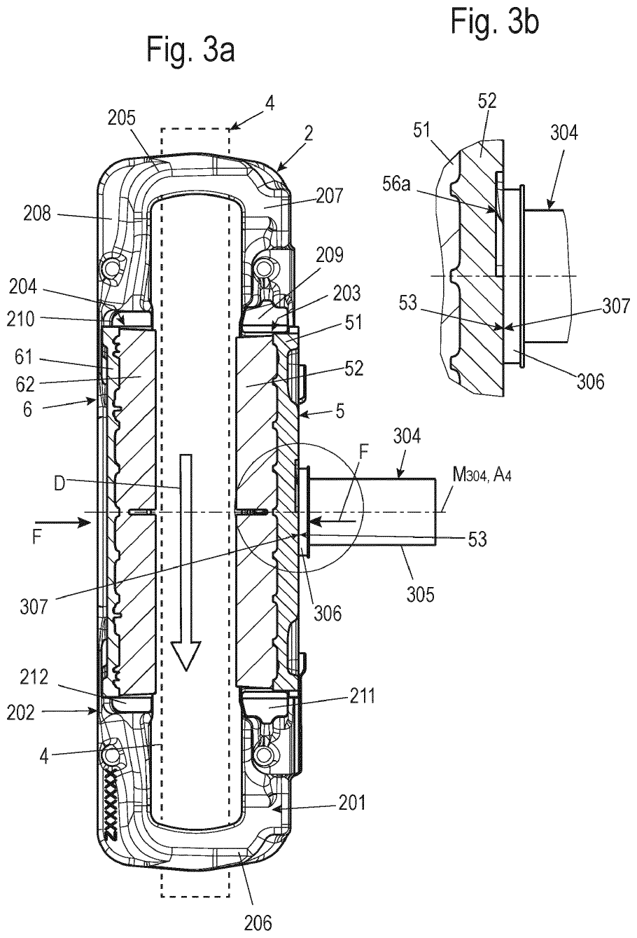

FIGS. 1 and 3 show elements and functional groups of a disc brake 1 having a brake carrier 2, a brake caliper 3 and a brake disc 4. The brake caliper 3 is guided so as to be displaceable on the brake carrier 2. This here is thus a sliding caliper disc brake. The disc brake is a brake for commercial vehicles. The vehicle can have a plurality of disc brakes of this type. The right and left disc brakes of the vehicle can in each case be designed according to the invention. The disc brake 1 is conceived for activation by a pneumatically driven actuator or by an electrically motorized actuator. The actuator can be, for example, a brake cylinder which by way of a piston rod acts on a brake lever (not illustrated here).

The brake disc 4 can preferably have a diameter of 330 mm or more (in turn preferably up to 432 mm). The tensioning device in the brake caliper 3 is disposed on the tensioning side 301 of the brake disc 4.

The brake caliper 3 in the manner of a frame engages across the upper periphery of the brake disc 4. The brake disc 4 has a preferred rotating direction D (FIG. 3). The latter corresponds to the rotating direction of the vehicle wheel of a vehicle during forward travel.

The brake carrier 2 likewise has a frame-type shape and encompasses an upper periphery of the brake disc 4. Said brake carrier 2 is fastened to a fastening means on the vehicle side (not illustrated here). This fastening is typically performed on a tensioning side of the disc brake. The brake carrier 2 and the brake caliper 3 correspondingly have in each case one tensioning side 201, 301 and one reaction side 202, 302. The brake carrier 2 furthermore has a tensioning-side pad take-up 203 and a reaction-side pad take-up 204.

The brake carrier in terms of the preferred rotating direction D of the brake disc 4 during forward travel has an ingress-side transverse stay 205 and an egress-side transverse stay 206. Said stays lie so as to be substantially perpendicular to a tensioning-side longitudinal stay 207 and a reaction-side longitudinal stay 208. Each of the two pad take-ups 203, 204 furthermore has one ingress-side carrier lug 209, 210 and one egress-side carrier lug 211, 212, wherein the respective brake pad 5, 6 when braking during forward travel is supported in the circumferential direction. The term “circumferential direction” refers to the movement of the brake disc in the direction D. Part of the brake disc 4, a type of annular segment, projects through the brake carrier 2 and upward from the latter, or at least protrudes into said brake carrier 2.

An “alignment in the circumferential direction” means that the corresponding element in the circumferential direction is aligned so as to be centered and centric in terms of this part of the brake disc. The element in this instance lies so as to be centric in front of the corresponding brake disc annular segment and is not displaced so as to be eccentric in terms of this segment. To this end, the element can have a central plane which is radially aligned with regard to the brake disc rotation axis A4, and it can also be provided to this end that the line of gravity of the element, for example a brake pad 5 or 6, also runs through this central plane so as to be parallel to the rotation axis A4 of the brake disc 4.

The brake pads 5, 6 are able to be inserted into the pad take-ups 203, 204, preferably through the opening 303 of the brake caliper, and are already inserted in FIG. 3. The brake pads 5, 6 have in each case one backplate 51, 61 and one friction material 52, 62. The friction material 52, 62 is in each case oriented toward the brake disc 4. The brake pads 5, 6 are displaceable parallel to the brake disc rotation axis A. This rotation axis A in FIG. 3 lies below the central axis M of a compression piston 304, so as to be parallel to said central axis M. The displacement of the brake pads 5, 6 takes place during braking and optionally as a compensation for wear on the pad. The brake pads 5, 6, and preferably the friction materials 52, 62 thereof, and preferably also the backplates 5, 6 thereof, in the circumferential direction can be aligned so as to be centered in terms the brake disc 4. The lines of gravity of these brake pads 5, 6, and preferably also the lines of gravity of the friction materials 51, 61 thereof and of the backplates 52, 62 thereof, in this instance in the circumferential direction preferably lie in the center of these respective elements. The brake caliper 3 has a central centric opening 303, the circumferential periphery of the brake disc 4 plunging into the latter. The brake pads 5, 6 can be inserted into the pad take-ups 203, 204 through this opening 303 when changing pads.

The brake caliper 3 on the tensioning side thereof has a tensioning installation (not illustrated or visible here with the exception of a compression piston 304). This tensioning installation can be disposed in an opening of the brake caliper 3. The tensioning installation serves for converting a tensioning movement of an element of the actuator into a tensioning movement. The tensioning movement to this end can have one or a plurality of elements such as, for example, a lever, a bearing and/or a traverse, wherein these elements act on the compression piston. The construction of such tensioning installations of the most varied types is known per se and is therefore not explained in detail here. The tensioning installation, not otherwise illustrated here, comprises the single compression piston 304 (see FIGS. 1, 2, and 3). This compression piston 304 can have a cylindrical or partially cylindrical portion 305. Said compression piston 304 on the end thereof that faces the brake pad 5 furthermore has a (here a single) compression piece 306 for acting on the tensioning-side brake pad 5, at least when tensioning the disc brake.

A compression face 307 is configured on the free end of the compression piece 306. The compression piece 306 can be configured so as to be integral to the cylindrical portion 305 or be attached to the latter. The cylindrical portion 305 can be configured as a tubular piece, in particular as a threaded tubular portion. The compression piece 306 can also be configured as a compression piece region which otherwise is indistinguishable from the portion 305 and merely configures the free end region of said portion 305, so to speak.

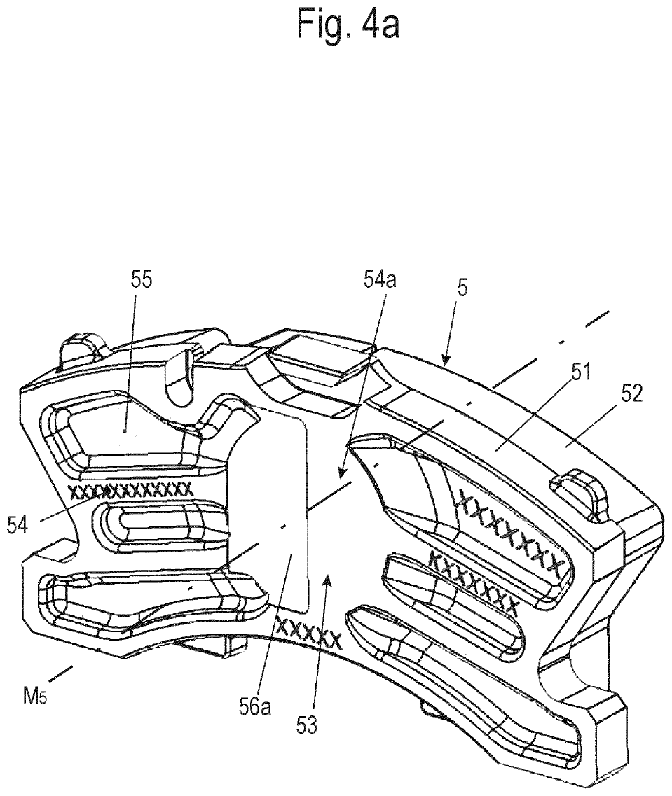

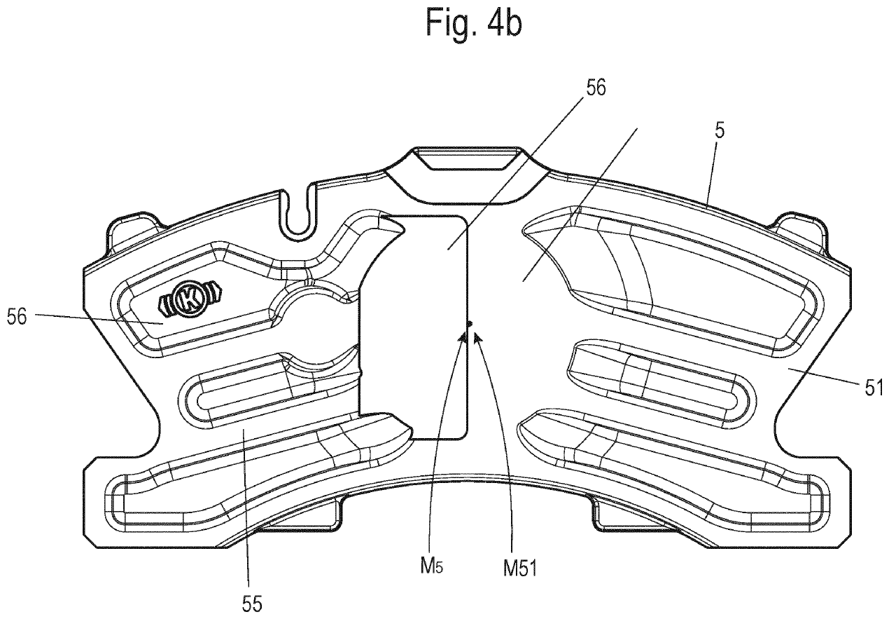

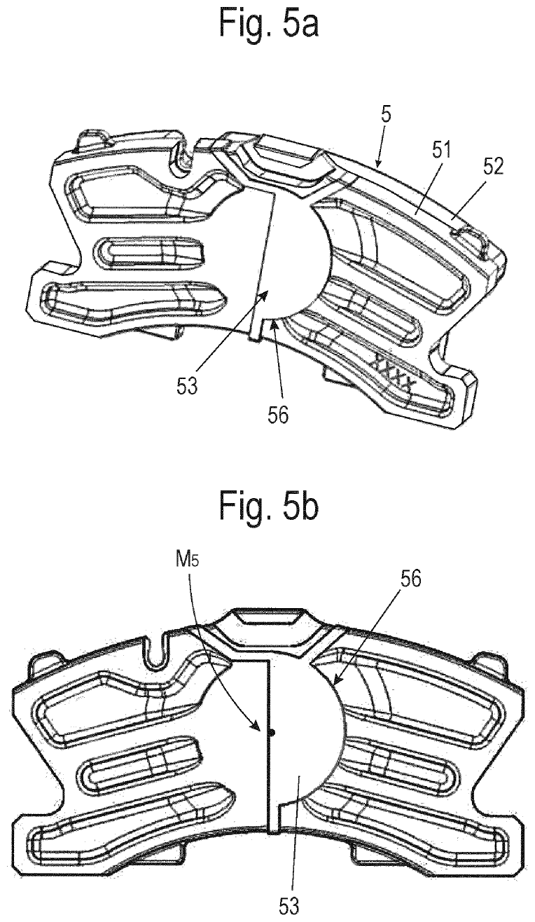

The backplate 51 of the tensioning-side brake pad 5 has a counter bearing face 53 which corresponds with the compression face and on which the compression face 304 is supported during braking. The backplate 51 otherwise can be configured so as to be flat or else also have ribs 54 and recesses/depressions 55 (FIGS. 4a, b, FIGS. 5a, b). Said ribs 54 and recesses/depressions 55, optionally having a rib 54a which forms the counter bearing face 53 in FIG. 4, can overall be distributed such that the line of gravity M5 of the brake pad 53 and preferably also the lines of gravity of the pad material or friction material, respectively, of said brake pad and of the backplate runs/run through a central axis M51 which (in terms of the external contour with the exception of deviations such as a recess for a sensor or the like) lies in a central plane and preferably a symmetry plane of the brake pad. These lines of gravity in the circumferential direction in this instance are preferably aligned so as to be centered in terms of the brake disc.

When braking, the compression piston 304 by way of the compression piece 306 and by the compression face 307 presses onto the backplate 51 of the tensioning-side brake pad 5. This displaces the tensioning-side brake pad 5 in the tensioning-side pad take-up 203 thereof in the direction of the brake disc 202 until the tensioning-side brake pad 5 comes into frictional contact with the surface of the brake disc 4 and decelerates the latter. The brake caliper 3 when braking, as a consequence of the tensioning procedure here, is displaced counter to the direction of movement of the compression piston 304, as a result of which the reaction-side brake pad 6 by way of the friction material 62 thereof is likewise pressed against the brake disc 4. The brake caliper 3 preferably acts in a comparatively fully planar manner on the backplate 62 of the reaction-side brake pad 6, the latter in the carrier take-up 204 thereof likewise being displaced axially in the direction of the brake disc 4, so as to be parallel to the axis of the brake disc 4. The rotating speed of the brake disc 4 when braking is reduced in this manner, and the vehicle provided with the corresponding disc brake is decelerated.

In the context of this document, the face on which the compression face 307 and the counter bearing face 53 when tensioning the brake bear on one another (see FIGS. 1, 2, 3) is referred to as the effective area. If an additional element such as, for example, a sheet-metal plate 56, see FIG. 4, is disposed on the backplate, the compression piston 304 acting on the backplate 51 by way of said sheet-metal plate 56, this element, in particular the sheet-metal, has to be added to the backplate 51 and in the context of this document is understood to be an element of the brake pad 5, 6.

It is provided that the effective area on which the compression face 304 and the counter bearing face 53 bear on one another when tensioning the disc brake, in the circumferential direction is not centered in terms of the brake disc but in the rotating direction is aligned in relation to said brake disc so as to be offset toward the egress side. It can furthermore be provided that the effective area in the circumferential direction is not aligned so as to be centered in terms of the central axis M304 of the compression piston 304, but, entirely or largely, in terms of the preferred rotating direction of the disc brake 1 lies relative to this central axis M304 so as to be offset toward the egress side.

This can be seen in FIG. 3 in that it corresponds to the force line F, or the force vector of the force by way of which the compression piston 304 acts on the brake pad 5, respectively, relative to the central axis M304 and relative to the brake disc rotation axis A4 lie so as to be offset in the egress direction.

According to one preferred design embodiment, the central axis M304 of the single compression piston 304 here can lie so as to be centric between two central axes M213, M214 of friction bearings 213, 214 of the disc brake 1, the brake caliper 3 by way of said friction bearings 213, 214 being guided so as to be displaceable relative to the brake carrier 2. These central axes M213, M214 in radial terms being preferably equidistant from the brake disc rotation axis A4.

The displacement of the effective area between the brake pad 5 and the compression piece 306 in the circumferential direction in terms of the brake disc 4 counteracts oblique wear in an effective and simple manner.

It is particularly advantageous that the brake pads 5, 6, and in particular the friction faces thereof, and also the pad take-ups, to not have to be offset relative to the central axis M304 of the compression piston 306. In the circumferential direction, said brake pads 5, 6 both remain aligned so as to be centered in terms of the brake disc 4 and also in terms of the central axis M304 of the piston 304. The lines of gravity (of the friction pads 52, 62 and/or of the backplate 51, 61) preferably run through the plane which is defined by M304 and A4.

A particular advantage of this design embodiment lies in that also in a disc brake which has only a single compression piston 304 and in which both the brake pads 5, 6 in the circumferential direction are aligned so as to be centered in terms of the central axis M304 and the brake disc 4, oblique wear can be counteracted, without an offset of a pad 5, 6 and/or the associated pad take-up 203, 204 thereof, simply in that the compression piece 306 and/or the backplate 51 of the brake pad 5 are/is modified such that the effective area in the circumferential direction lies so as to be eccentric, or is not centric and aligned so as not to be centered in terms of the brake disc, respectively. This measure is able to be implemented in a simple manner in a retrofit process and/or by a simple constructive modification of the elements comprising the compression piece 306 and/or the tensioning-side brake pad 5.

When braking, the compression face 307 of the compression piston 304 presses on the backplate 51 of the tensioning-side brake pad 5 only in the region of the effective area.

The compression piston 304 comprises the central axis M304. The pad take-ups 203, 204 in terms of this central axis M304 and in terms of a plane which is defined by the central axis M304 and the brake disc rotation axis A4 are in each case of preferably symmetrical construction. This means that the support faces on the ingress-side and the egress-side carrier lugs 209, 210; 211, 212 are in each case equidistant from the central axis M304. The friction pads 52, 62 here can also be conceived so as to be correspondingly symmetrical in relation to the central axis. The lines of gravity of said friction pads 52, 62 in this instance can lie on the plane defined by M304 and A4. This can mean in particular that the friction pads 5, 6, in terms of the central axis M304 of the compression piston 304, in the circumferential direction of the brake disc lie so as to be centered in terms of the compression piston 304 and the brake disc 4 and, in terms of the preferred rotating direction of the brake disc 4 and the brake disc 4, do not lie so as to be offset to the ingress-side or the egress-side.

When braking, the compression piece 306 by way of the force vector F in the line of force aligned therewith in the effective area, acts on the backplate 51 of the tensioning-side brake pad 5. The compression piece 306 in the disc brake can be aligned so as to be centered in the circumferential direction or the rotating direction, respectively.

The friction material 52 of the tensioning-side brake pad 5, and the friction material 62 of the reaction-side brake pad 6, lie so as to be in each case displaced by the same amount toward the direction of the ingress side (at 205) only in terms of this force vector F. The effect of oblique wear on the brake pads 5, 6 can be counteracted in a simple manner as a result.

In order for the eccentric effective areas to be configured between the compression piece 306 and the tensioning-side brake pad 5, one or a plurality of constructive measures are required.

In order for the effective area offset toward the egress side to be configured between the compression piece 306 and the tensioning-side brake pad 5, according to one variant the compression piece can thus have an appendage 308 in the context of a symmetrical protrusion in the direction of the brake pad 5, said protrusion being offset toward the egress side and not being symmetrical in relation to the plane defined by M304 and A4 (FIGS. 1 and 2).

This appendage 308 can be designed in the manner of an annular segment. Said appendage 308 can however also be configured so as to be substantially semi-cylindrical, for example. However, said appendage 308 could also be differently configured, for example so as to be rectangular in the region of the counter bearing face 53. Said appendage 308 acts on the counter bearing face 53 in such a manner. This counter bearing face can be of a corresponding design, thus for example likewise in the manner of an annular segment. Said counter bearing face can however also be differently designed, for example so as to be circular or else rectangular.

According to another variant however, the compression face 307 of the compression piece 304 in the circumferential direction may not be offset toward the egress side but designed so as to be concentric with and/or symmetrical in relation to the central axis, for example, and the counter bearing face 53 of the brake pad 5 can be designed in such a manner that the effective area nevertheless lies so as to be displaced toward the egress side such that the effective force vector F1 is offset toward the egress side.

According to one variant, the compression face 307 of the compression piece 306 can thus be displaced eccentrically toward the egress side. Or else the counter bearing face 53 can be displaced toward the egress side. However, both faces can also be offset toward the egress side.

To this end it is conceivable for an eccentric contact pressure contour as a protrusion 56 in relation to the surrounding face of the backplate 51 to be provided on the backplate 51 of the tensioning-side brake pad 5, said contact pressure contour lying so as to be eccentric in terms of the central axis M of the compression piston 304 and lying so as to be raised in relation to at least one surrounding region such that the compression piece 304 by way of a suitably flat compression face 307 acts only on this contact pressure contour 54. This can also be achieved in that a corresponding depression 56a is provided on the ingress-side in the backplate 51, said depression 56a not contacting the compression face of the compression piece which otherwise is preferably flat (FIG. 3).

An integral protrusion of the backplate 51 can also be provided, or else a separate element such as an add-on plate 55 can be attached as a protrusion on the backplate.

The add-on plate 51 can be welded to the backplate or fastened thereto in a different manner. Alternatively, an integral appendage as a protrusion 56 in the manner of a raised region can also be configured on the backplate 51 (FIGS. 5a, 5b).

Alternatively, a sheet-metal plate forming an appendage (as a protrusion) could also be fixed to the compression piece (not illustrated).

It can be provided that the entire effective area in the egress direction lies so as to be lateral to the central axis M304.

It can however also be that the central axis M304 runs through the effective area and the latter toward the egress side has a larger extent than toward the ingress side. As a result of distributing the recesses 55 and/or ribs 56 in a corresponding manner on the backplate 51, the lines of gravity and the effective center of gravity of the entire pad 5 and also of the friction material 52 in the circumferential direction can furthermore be aligned toward the central axis M1 of the compression piston 304.

The semicircular contour or annular-segment contour of the effective area illustrated is advantageous. It is furthermore advantageous for the entire effective area to lie so as to be lateral to the central axis. This is preferred but not mandatory.

The compression piece 306 at the end of the compression piston 304 can be designed so as to be substantially cylindrical wherein the compression face 307 in this instance is preferably flat. Said compression face 307 can be disposed so as to be centric.

The compression piece 306 can also be configured so as to be oval, for example, and lies so as to be displaced in the direction of the egress side, or be attached so as to be eccentric on the end of the portion 305, respectively.

It can however also be that the central axis runs through the effective area and the latter toward the egress side has a larger extent than toward the ingress side.

In the case of right and left disc brakes of a vehicle, the effective areas on which the compression face 304 and the counter bearing face 53 bear on one another when tensioning the disc brake, in terms of the preferred rotating direction of the brake disc 4 and the central axis M of the piston 304, in the circumferential direction are in each case offset toward the egress side.

In order for this condition to be met, the tensioning-side brake pads of the right disc brake of the vehicle, according to one variant, can have a different backplate than the tensioning-side brake pads of the left disc brake.

According to one variant, the disc brake 1 for the right end of the axle, i.e. “the disc brake on the right vehicle side”, except for the two brake pads thereof, in terms of construction can be configured so as to be substantially identical to the disc brake 1 for the left end of the axle, i.e. “the disc brake on the left vehicle side” (in particular the pad take-ups of the brake carrier and the compression pieces of the tensioning installations). However, individual elements such as, for example, the sliding bearings, fixed bearings and floating bearings, for the right and the left disc brake can however also lead to a differentiation, because when both fixed bearings are to be disposed on the “ingress side” of the disc brake, for example, corresponding differences result in this region in the case of the left disc brake and the right disc brake.

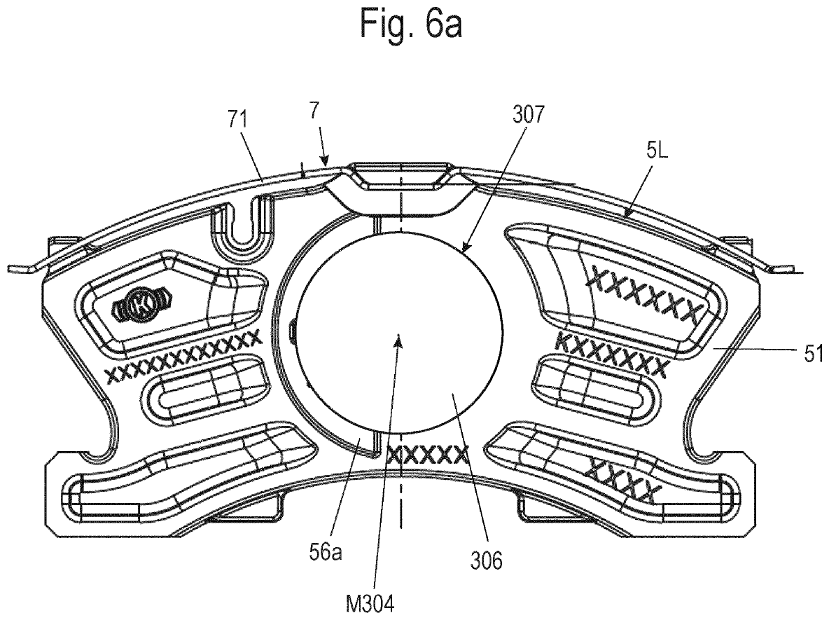

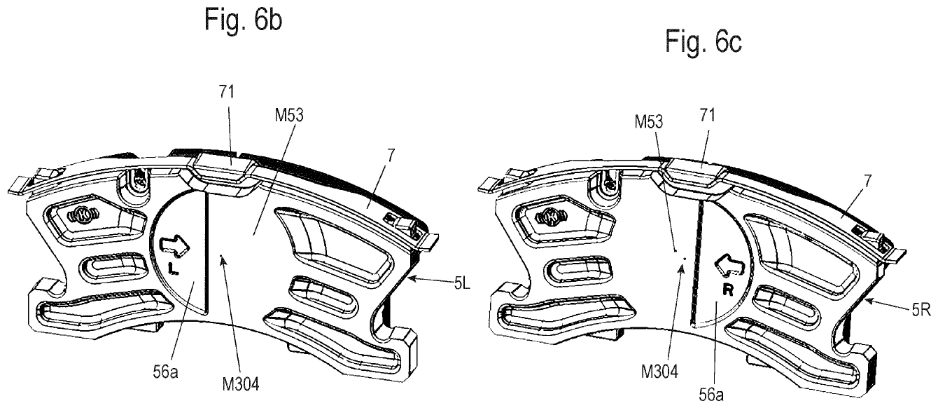

The recesses 56a here can be configured such that said recesses 56a are mutually aligned, in particular completely mutually aligned, when the back plates thereof are placed so as to be congruent on top of one another (FIGS. 6b, 6c).

The recess 56a of the tensioning-side brake pad 5, for example in the case of a right disc brake and a tensioning-side brake pad 5 in the installed state in the backplate can thus lie so as to be entirely or largely more to the one side, for example the right side, of the central axis, and in the case of the corresponding left disc brake and a tensioning-side brake pad 5 in the installed state in the backplate can lie so as to be entirely or largely more toward the other side, for example the left side, of the central axis (FIGS. 6a, 6b, 6c). In this instance it can be advantageous to mark whether a brake pad is provided or conceived, respectively, for a left or a right vehicle side, or if the disc brake assembled there is provided or conceived, respectively, for the right or the left vehicle side.

FIG. 6 shows this in a very illustrative manner. FIG. 6a) thus shows a perspective view of a tensioning-side brake pad 5L for a disc brake on the left vehicle side, wherein it is illustrated by a circular area where a preferably flat compression face 307 of the compression piece acts on the backplate 51. FIG. 6 in b) furthermore shows the tensioning-side brake pad 5L for the disc brake on the left vehicle side without the indicated compression face 307. FIG. 6c then shows a tensioning-side brake pad 5R for a disc brake on the right vehicle side, wherein the recess 56a or depression of the brake pad on which the compression piston 305 acts by way of the compression piece 306 (see also FIG. 5), in the case of the left disc brake lies further toward the left on the backplate 51, and in the case of the right disc brake lies further toward the right on the backplate (in terms of the center of the backplate). Since the recess 56a lies entirely or partially on the ingress-side in the backplate so as to be below the compression face, the effective area in the circumferential direction lies so as to be eccentric, or is not centric and aligned so as not to be centered in terms of the brake disc, respectively.

It is still to be added that the brake pad 5, 6 can have a holding-down spring 7 which is associated with a cap 7a by way of which the holding-down spring 7 can be fastened to the actual brake pad.

### REFERENCE SIGNS

| | |
|---|---|
| Disc brake | 1 |
| Brake carrier | 2 |
| Tensioning side | 201 |
| Reaction side | 202 |
| Tensioning-side pad take-up | 203 |
| Reaction-side pad take-up | 204 |
| Transverse stay | 205, 206 |
| Longitudinal stay | 207, 208 |
| Ingress-side carrier lug | 209, 210 |
| Egress-side carrier lug | 211, 212 |
| Friction bearing | 213, 214 |
| Brake caliper | 3 |
| Tensioning side | 301 |
| Reaction side | 302 |
| Opening | 303 |
| Compression piston | 304 |
| Cylindrical portion | 305 |
| Compression piece | 306 |
| Compression face | 307 |
| Appendage | 308 |
| Brake disc | 4 |
| Brake pads | 5, 6 |
| Backplate | 51, 61 |
| Friction material | 52, 62 |
| Counter bearing face | 53 |
| Ribs | 54 |
| Recesses, depressions | 55 |
| Protrusion | 56 |
| Depression | 56a |
| Line of gravity | M5 |
| Central axis | M51 |
| Central axis | M304 |
| Rotation axis | A4 |
| Rotating direction | D |

1.-22. (canceled)

23. An electrically or pneumatically activatable disc brake for a commercial vehicle, comprising:
a brake disc having a preferred rotating direction;
a brake carrier;
a brake caliper which is guided so as to be displaceable on the brake carrier;
a tensioning-side brake pad and a reaction-side brake pad which, in a tensioning-side pad take-up and in a reaction-side pad take-up of the brake carrier, are disposed so as to be displaceable parallel to a brake disc rotation axis;
a tensioning device which has a single compression piston which has a central axis and which, on an end facing the tensioning-side brake pad, has a compression piece by way of which a compression face acts on a corresponding counter bearing face of the tensioning-side brake pad such that, when tensioning the brake, an effective area is configured between the compression face and the counter bearing face;
wherein the tensioning-side brake pad and the reaction-side brake pad in the circumferential direction are aligned so as to be centered in terms of the brake disc and the central axis of the piston, and
wherein the effective area, on which the compression face and the counter bearing face bear on one another when tensioning the disc brake, in the circumferential direction, lies so as to be offset toward the egress side in terms of the preferred rotating direction of the brake disc and the central axis of the piston.

24. The disc brake as claimed in claim 23, wherein
the tensioning-side brake pad and the reaction-side brake pad are disposed in a tensioning-side pad take-up and disposed in a reaction-side pad take-up of the brake carrier so as to be displaceable parallel or substantially parallel to a brake disc rotation axis.

25. The disc brake as claimed in claim 23, wherein
the compression piece, at least when tensioning the disc brake, is configured for acting on the tensioning-side brake pad.

26. The disc brake as claimed in claim 23, wherein
the brake disc has a diameter of 330 mm or more.

27. The disc brake as claimed in claim 23, wherein
the brake caliper and the brake carrier, in the manner of a frame, engage in each case across an upper periphery of the brake disc, wherein a central opening for changing pads is provided in the brake caliper.

28. The disc brake as claimed in claim 23, wherein
the brake pads have, in each case, one backplate and one friction material, and
the friction materials and/or the backplate in the circumferential direction are aligned so as to be centered in terms of the brake disc.

29. The disc brake as claimed in claim 23, wherein
the backplate has a row of ribs and of recesses/depressions.

30. The disc brake as claimed in claim 23, wherein
the pad take-ups of the brake carrier in the circumferential direction are aligned so as to be centered in terms of the brake disc.

31. The disc brake as claimed in claim 23, wherein
the compression piece has a protrusion which comprises the compression face, and
the compression face, in terms of the preferred rotating direction of the brake disc, in the circumferential direction is disposed so as to be offset toward the egress side.

32. The disc brake as claimed in claim 23, wherein
the counter bearing face of the backplate, in terms of the preferred rotating direction of the brake disc, in the circumferential direction is disposed so as to be offset toward the egress side.

33. The disc brake as claimed in claim 32, wherein
the counter bearing face of the backplate of the tensioning-side brake pad is configured by an appendage of the backplate.

34. The disc brake as claimed in claim 33, wherein
the appendage is formed by an element attached to the backplate of the tensioning-side brake pad.

35. The disc brake as claimed in claim 34, wherein
the element attached to the backplate of the tensioning-side brake pad is a sheet-metal element which is fastened to the backplate.

36. The disc brake as claimed in claim 23, wherein
the backplate of the brake pad has a recess which, relative to the brake disc rotation axis, lies below the compression piece so as to be entirely or partially displaced to the ingress side such that the backplate does not contact the compression piece in the region of the recess and that the brake pad, when braking, contacts the compression piece in the region next to the recess.

37. The disc brake as claimed in claim 29, wherein
as a result of the recesses and/or ribs being distributed on the backplate, the lines of gravity and the effective center of gravity of the entire pad and also of the friction material in the circumferential direction are aligned toward the central axis M1 of the compression piston.

38. The disc brake as claimed in claim 23, wherein
the tensioning device in the brake caliper is disposed on the tensioning side of the brake disc, and
the brake caliper in the manner of a frame encompasses a circumferential region of the brake disc.

39. A brake pad for use with a disc brake as claimed in claim 23, wherein
said brake pad, in terms of the line of gravity thereof, has a single eccentric counter bearing face for a compression piston having a compression face.

40. The brake pad as claimed in claim 39, wherein
said brake pad has a single eccentric counter bearing face and,
the single eccentric counter bearing face is configured so as to be substantially semicircular or configured so as to be completely semicircular.

41. The brake pad as claimed in claim 39, wherein
the backplate of said brake pad has a recess which, relative to the brake disc rotation axis, lies below the compression piece so as to be entirely or partially displaced toward the ingress side such that the backplate does not contact the compression piece in the region of the recess.

42. The brake pad as claimed in claim 41, wherein the recess has the shape of a segment of a circle.

43. The brake pad as claimed in claim 39, wherein
as a result of recesses and/or ribs being distributed on the backplate, lines of gravity and the effective center of gravity of the entire pad and also of the friction material in the circumferential direction are aligned toward the central axis of the compression piston.

44. A vehicle, comprising:
at least one wheel axle, wherein
the wheel axle, in terms of a primary travel direction of the vehicle, has a primary rotating direction,
the wheel axle on a left vehicle side has at least one disc brake assigned to a left end of the wheel axle, and
the wheel axle on the right vehicle side has at least one disc brake assigned to a right end,
the disc brake on the left vehicle side and the disc brake on the right vehicle side in each case comprise:
a brake disc having a preferred rotating direction;
a brake carrier;
a brake caliper which is guided so as to be displaceable on the brake carrier;
a tensioning-side brake pad and a reaction-side brake pad which, in a tensioning-side pad take-up and in a reaction-side pad take-up of the brake carrier, are disposed so as to be displaceable parallel to a brake disc rotation axis;
a tensioning device which has a single compression piston which has a central axis and which, on an end facing the tensioning-side brake pad, has a compression piece by way of which a compression face acts on a corresponding counter bearing face of the tensioning-side brake pad such that, when tensioning the brake, an effective area is configured between the compression face and the counter bearing face;
wherein the tensioning-side brake pad and the reaction-side brake pad in the circumferential direction are aligned so as to be centered in terms of the brake disc and the central axis of the piston, and
wherein the effective area, on which the compression face and the counter bearing face bear on one another when tensioning the disc brake, in the circumferential direction, lies so as to be offset toward the egress side in terms of the preferred rotating direction of the brake disc and the central axis of the piston.
